(19) United States
(12) Patent Application Publication
(10) Pub. No.: US 2023/0393964 A1
(43) Pub. Date: Dec. 7, 2023

(54) SYSTEM AND METHOD TO DYNAMICALLY SELECT TEST CASES BASED ON CODE CHANGE CONTENTS FOR ACHIEVING MINIMAL COST AND ADEQUATE COVERAGE

(71) Applicant: Dell Products L.P., Round Rock, TX (US)

(72) Inventors: Guanyu Li, Beijing (CN); Hongbin Deng, Beijing (CN); Veenu Gupta, Milpitas, IN (US)

(21) Appl. No.: 17/805,282

(22) Filed: Jun. 3, 2022

(51) Int. Cl. G06F 11/36

(52) U.S. Cl. CPC G06F 11/3684; G06F 11/3688; G06F 11/3692; G06F 11/3676

(57) ABSTRACT

One example method includes discovering a mapping of software components to source files, mapping code changes of a software build to the software components, collecting metric data for test cases, and based on the mapping, and the collecting, selecting a test set, which may include one or more test cases, that covers all the code changes so that when one or more tests of the test case are run, the tests operate to test all the code changes.

### FIELD OF THE INVENTION

Embodiments of the present invention generally relate to testing code. More particularly, at least some embodiments of the invention relate to systems, hardware, software, computer-readable media, and methods for dynamically selecting test cases for functional components in a way that minimizes cost, while also ensuring that testing coverage is achieved for the functional components that need to be tested.

### BACKGROUND

In complex software development processes and development pipelines, a commonly used engineering process is to separate the complex software into multiple functional components, and also to group engineers into different functional components teams. Code changes made by the engineers are checked-in every day by different components teams, test cases are created accordingly then cataloged and accumulated to specific components also.

When a new software build is generated, exhaustive testing with all existing test cases will be executed often, which requires large infrastructure investment and is time-consuming. In fact however, such testing may not always be necessary, especially when only small portions of source code change for the new software build.

Defining dynamic test cases set based on the code changes that ensure adequate coverage for the changes may significantly reduce runtime and costs.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example architecture for some embodiments.

FIG. 2 discloses example formulas for use in a mapping discovery process.

FIG. 3 discloses an example formula for use in mapping.

FIG. 4 discloses an example data structure for storing mapping information.

FIG. 5 discloses an example of code changes for a new software build.

FIG. 6 discloses mappings that may be used to determine minimal unions.

FIG. 7 discloses aspects of example test cases.

FIG. 8 discloses example cost, and value, formulas.

FIG. 9 discloses an example data structure that stores some possible test case combinations and corresponding Cost( ) and Value( ) are shown.

FIG. 10 discloses example pseudocode for mapping code changes to a minimal union of components.

FIG. 11 discloses example pseudocode for selecting test cases for a combined coverage with measurable cost( ) and value( ).

FIG. 12 discloses aspects of an example method according to some embodiments.

FIG. 13 discloses aspects of an example computing entity, comprising hardware and/or software, operable to perform any of the claimed methods, processes, and operations.

### DETAILED DESCRIPTION OF SOME EXAMPLE EMBODIMENTS

Embodiments of the present invention generally relate to testing code. More particularly, at least some embodiments of the invention relate to systems, hardware, software, computer-readable media, and methods for dynamically selecting test cases for functional components in a way that minimizes cost, while also ensuring that testing coverage is achieved for the functional components that need to be tested.

In general, example embodiments of the invention are directed to approaches that are based on the multi-components engineering process. Instead of running all accumulated test cases, example embodiments attempt to narrow down the testing scope and select efficient test cases for adequate coverage of the code changes. Example embodiments may comprise the following elements: (1) a process to discover mapping of components and their typical source files—the discovered mapping may be used to map code changes to specific components; (2) a process to map code changes of a new build to components incrementally; (3) a process to collect test cases metric data—the metric data may be used as supporting info for test cases selecting, and the metric data may be used the metric data can be used to measure test case value and cost; and (4) a process to select test cases for combined coverage of code changes. Instead of directly selecting test cases across components, example embodiments may map code changes to components first, possibly a limited number of components, then select test cases from a components test cases pool with configurable criteria. In this way, the amount of testing needed may be kept to a minimum, while also ensuring that suitable testing is performed with respect to those components that need it.

At present, there is no conventional approach available that is able, as the disclosed embodiments are, to map the code changes of a new build into functional components in the way described herein. Nor are conventional approaches able to then dynamically select test cases with minimal cost and high efficiency for adequate coverage of the code changes.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, an embodiment may reduce an amount of testing needed for a software build, while still ensuring that components of the software build are adequately tested. An embodiment may enable relatively faster testing of components of a software build, relative to the amount of time that would be required for testing if an embodiment of the invention were not employed. Various other advantages of example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Aspects of an Example Architecture and Environment

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that are operable to enable the building of software, and software components. An example architecture for some embodiments may comprise a software development pipeline, although the scope of the invention is not limited to any particular architecture.

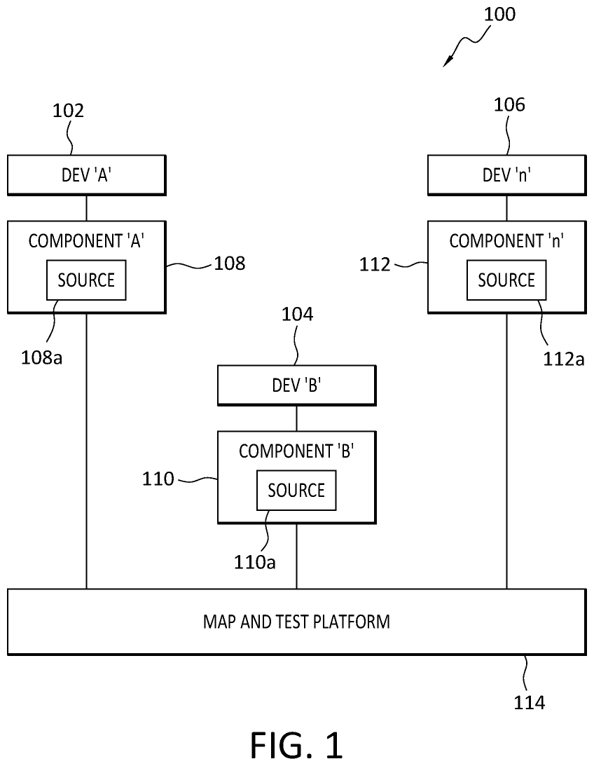

With particular attention now to FIG. 1, one example of an operating environment for embodiments of the invention is denoted generally at 100. In general, the operating environment 100 may comprise a variety of software development platforms 102, 104, and 106. Any type and number of software development platforms 102-106 may be employed. The software development platforms 102-106 may, or may not, be the same as each other. Each of the software development platforms 102-106 may be associated with a respective software development team comprising one or more developers and other personnel.

Each software development team may use its respective software development platform 102-106 to generate a respective software component 108, 110, and 112, or simply ‘component.’ Each of the software components 108, 110, and 112, may comprise a respective set 108a, 110a, and 112a, of one or more source files. No particular type or number of source files is required by any embodiment.

The various software development platforms 102, 104, and 106, may communicate with a map and test platform 114. The map and test platform 114 may implement any of the disclosed processes, or portions thereof, relating to mapping, and software development and testing. The map and test platform 114 may be hosted on a server or other system, which may comprise hardware and/or software, accessible by the software development platforms 102, 104, and 106.

In operation, briefly, the software development platforms 102, 104, and 106, may create and modify the respective software components 108, 110, and 112. As changes are made to the software components 108, 110, and 112, the software development platforms 102, 104, and 106 may submit any new or modified code for the software components 108, 110, and 112 to the map and test platform 114 which, as disclosed in more detail elsewhere herein, may operate to test the new and modified code.

### B. Overview

Example embodiments are directed to systems and methods that are based on a multi-component engineering process for software development. Instead of running all accumulated test cases for all code changes, embodiments may operate to narrow down the testing scope and select efficient test cases for adequate coverage of the code changes.

An example embodiment may comprise various processes. Following is a brief description of examples of each of the processes which may or may not be performed in the order indicated in that brief description. A more detailed discussion of the processes is set forth elsewhere herein.
A process to discover mapping of components and their typical source files. (1) Text analysis methodology may be used for discovering the mapping info. (2) The discovered mapping may be recorded into a DB (database) then loaded out when necessary. (3) The discovered mapping may be used to map code changes to specific components
A process to map code changes of a new build to components incrementally.
A process to collect test cases metric data. (1) The metric data may be used as supporting info for test cases selecting. (2) The metric data may be used to measure test cases' value and cost. (3) The metric data may be recorded into DB also periodically refreshed,
A process to select test cases for combined coverage of code changes. (1) Measurable Cost( ) and Value( ) may be calculated also for selected test cases.

Instead of directly selecting test cases across components, some example embodiments may operate to map code changes to particular components first, then select a subset of test cases from components test cases pool. There may be various aspects to this approach. For example, the test cases selecting may focus on a functional, and not purely on a coverage, perspective. As another example, the selected test cases may be such that they do not skip test points or test assertions.

As discussed in more detail elsewhere herein, example embodiments may comprise various functionalities. For example, embodiments may operate to discover and record the mapping of components and their typical source files in the form of an adjacency list. As another example, embodiments may operate to map code changes of a new software build to a minimal union set of components so as to define a narrowed testing scope. Further, example embodiments may operate to use formula-based selecting logic to select the most efficient test cases for combined coverage of the code changes.

### C. Aspects of Some Example Embodiments

Following are disclosed various aspects of example processes which may make up elements of an overall process according to some embodiments. The following discussion is presented by way of illustration and is not intended to limit the scope of the invention in any way.

C.1 Discover Mapping of Components and Source Files as Adjacency List

For discovering the mapping of components and their typical source files, a text analysis methodology may be employed. While source code instrumentation-based code coverage technology could be used to attempt to discover such mapping, such an approach may be problematic. For example, in complex software system, it is often the case that several different kinds of programming languages are being used, while source code instrumentation-based code coverage technology is language specific. Thus, a single coverage technology may not work in circumstances where multiple programming languages are involved. Moreover, source code instrumentation that may be required by a code coverage solution may compromise software behaviors or cause a software performance issue due, for example, to the coverage data collecting process being too cumbersome, intrusive, and resource-intensive.

In processes according to example embodiments, a general text analysis methodology, and formulas such as TF*IDF, and related theory and method, may be employed. A basic introduction concerning these aspects, including the formula TF*IDF, can be found at: https://en.wikipedia.org/wiki/Tf%E2%80%93idf. As well, more detailed information concerning TF*IDF can be found in ‘Appendix A’ attached hereto, and incorporated herein in its entirety by this reference.

Following is a discussion of various ways in which a text analysis approach may be employed to discover the mapping information, that is, information indicating a mapping of software components with their respective source files, which may be typical source files for the software components.

One or more of the following considerations may apply to the use of a text analysis approach in obtaining mapping information:
Engineers in the same component development team may be most likely to contribute code changes for their own components;
Historical code changes of one component team may be treated as a single, large, document, all such ‘documents’ of each component team may be treated collectively as a corpus;
To discover the most typical source files for each component, may be considered as equivalent, or analogous, to discovering the most typical keywords for each big document; and
It is not necessary to have one-to-one mapping between source files and a component—rather, it may be acceptable that some source files are mapped to more than one component, which may be normal in some circumstances.

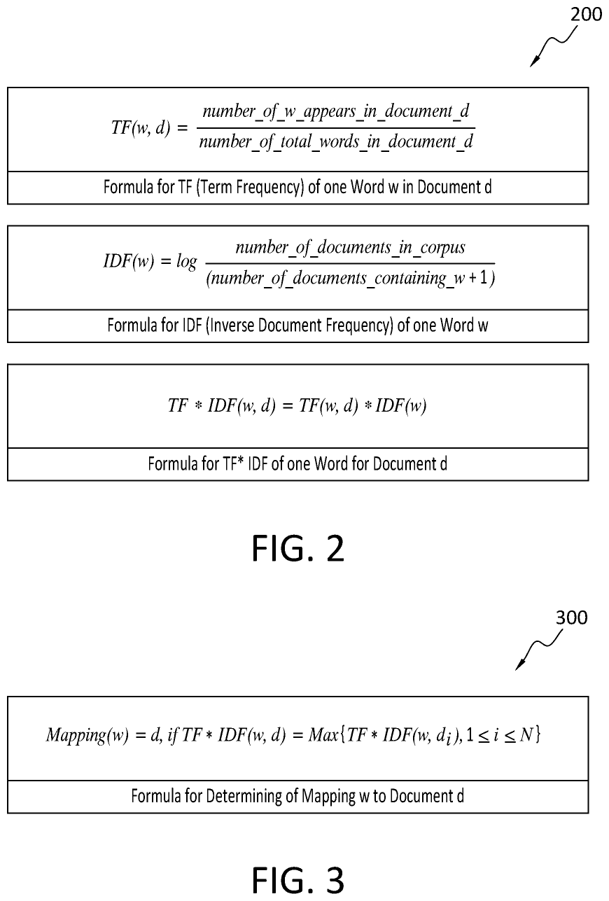

With reference now to FIG. 2, the numerical statistic TF*IDF (Term Frequency-Inverse Document Frequency), may be employed in an example mapping process. FIG. 2 discloses various formulas 200 related to TF*IDF.

The IDF formula definition may indicate, for example, how rarely/commonly a keyword appears in a particular document. If a keyword is so common that it occurs for all N documents of a corpus, then IDF(w)=log(N/(N+1)), which approaches 0, and if some keyword occurs only in one document, then IDF(w)=log(N/2), the maximum theoretical value of IDF(w) for the corpus.

A mapping discovery process may begin with definition of the maximum and acceptable number of components to which a source file is, or may be, mapped, named as Max_Mapped_Comps. Then, the mapping relationship can be determined for the source files, if the source file IDF(w)>=log(N/(Max_Mapped_Comps+1)).

After defining the maximum and acceptable number of components, the quantity of the source files to be considered in the mapping process may be reduced. The TF*IDF(w,d) may be calculated for each of the rest of the source files. Then, the mapping of the source files and components may be determined as shown in the formula 300 of FIG. 3 for each source file. Following is an illustrative example, from an actual project, of the discovery of the mapping for components and source files.

In this illustrative example:
historical code changes: 21720 code changes against 9336 unique source files from 48 different component teams;
by defining the Max_Mapped_Comps=3, which means that it is acceptable for a source file to be mapped to, at most, 3 different components, then in this case, IDF(w)=log(48/(3+1))=log(12)=1.0792;
with any IDF(w)>1.0792, which means the ‘w,’ or say the source file being changed by fewer than 3 of the software development teams, then the mapping can be directly determined for the source file—in the real project, mapping info can be directly determined for more than 5000 source files; and
for the rest of the source files whose IDF(w)<1.0792, formula mapping(w) can be used—in this approach, each of these source files may be mapped to the component for which the source file has the maximal TF*IDF(w,d) value.

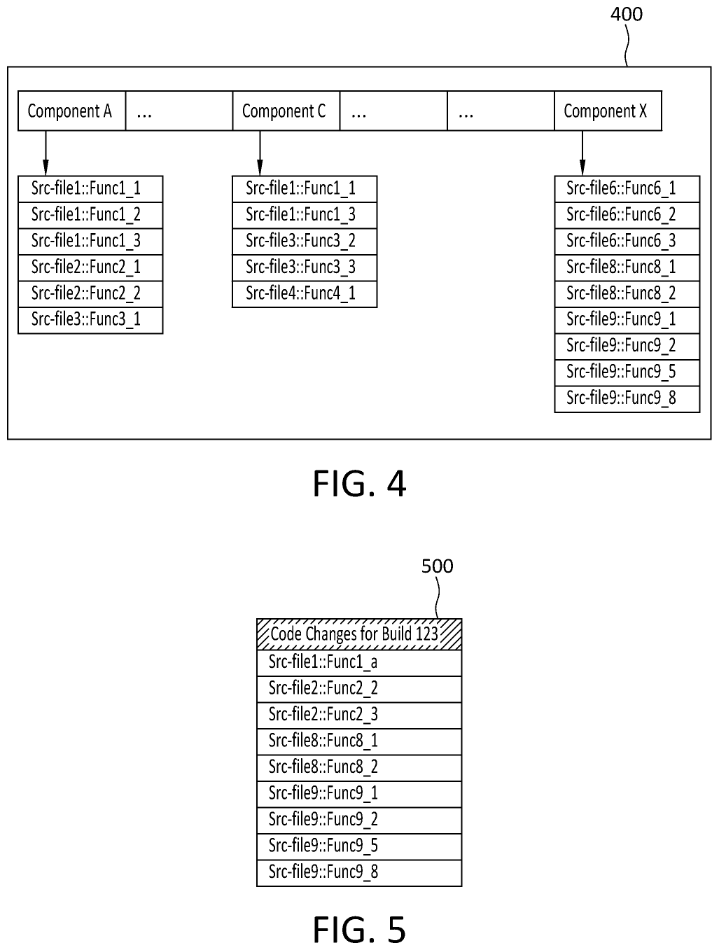

After completing the discovery of the mapping of components and their typical source files, the next process, in some embodiments at least, is to parse and collect all the subroutines of each source file that has been mapped. Finally, the mapping info and all associated subroutines may be recorded into a DB for further usage. Moreover, for using the mapping info, a data structure 400, one example of which is disclosed in FIG. 4, may be created in-memory by loading the mapping out of the DB. Data structures such as the data structure 400 may be referred to herein as an adjacency list since the data structure shows the relationship between various source files and components. As shown in the example of FIG. 4, a ‘Component A’ has various source files mapped to it, such as ‘Src-file1’ for example, each of which may be executable to perform a different respective function, such as ‘Func1_1, for example. The ‘Component C’ and ‘Component X’ similarly have mappings in the data structure 400.

C.2 Process to Map Code Changes of a New Software Build to Components

After the various source files have been mapped to components, the next process, to map code changes to components, may operate to collect all code changes checked-in during a build range. The build range may begin, for example, with the latest tested build, and end with the current new build to test. Thus, the build range in this example may encompass all of the untested changes.

The process to map code changes to components may also extract the changed source files and subroutines from the code changes, then describe the changes source files and subroutines with data-structure as shown in the example mapping 500 in FIG. 5, which discloses various code changes for a software build denoted ‘Build 123.’ To illustrate, the Src-file1::Func1_a means that code changes against subroutine Func1_a in Src-file1 have been made, and are now contained in the new Build 123.

Using the data structures 400 and 500, the process to map code changes to components may operate to map the changes into components using the following operations:
(a) for each extracted source file and subroutine pair— (1) traverse the adjacency list (see reference 400), and (2) collect out all the components which contain that pair;
(b) repeat (a) for all extracted source file and subroutine pairs;
(c) find a minimal union of the components to cover all, or most, of the extracted source files and subroutines pairs; and
(d) collect any source files or subroutines which cannot be mapped to any components— (1) if new test cases being created, run the new test cases for the new build, and (2) if no new test case, run pre-defined baseline test cases for the new build.

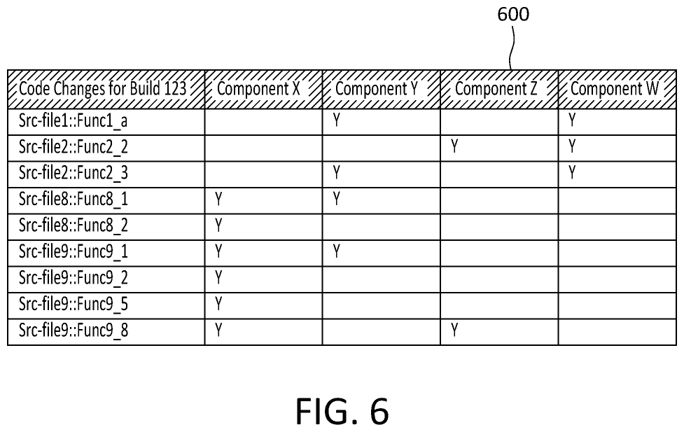

The rationale for finding a minimal union of the components is explained below with reference to the table 600 in FIG. 6. In general, the table 600 includes information that may enable a determination to be made as to minimal union of components for code changes.

For example, as shown in the example of FIG. 6, various source files have been modified, and these are denoted ‘Code Changes for Build 123.’ The table 600 maps the source files to the components that include or use those source files. Thus, an aim of this process may be to test all of the code changes, but do so in a way that minimizes the number of components that must be tested. By keeping the number of components tested to a minimum, the time and expense associated with testing may be likewise minimized.

In the particular example of FIG. 6, it can be seen that the union of Components X, Y, and Z, embraces all of the source files that have been changed. Thus, all the changed source files could be tested by testing Components X, Y, and Z. However, it can also be seen that a smaller group of components, namely, Components X and W, also embraces all of the source files that have been changed. Thus, there are two groupings of components that can be checked to ensure that all the changed source files are tested.

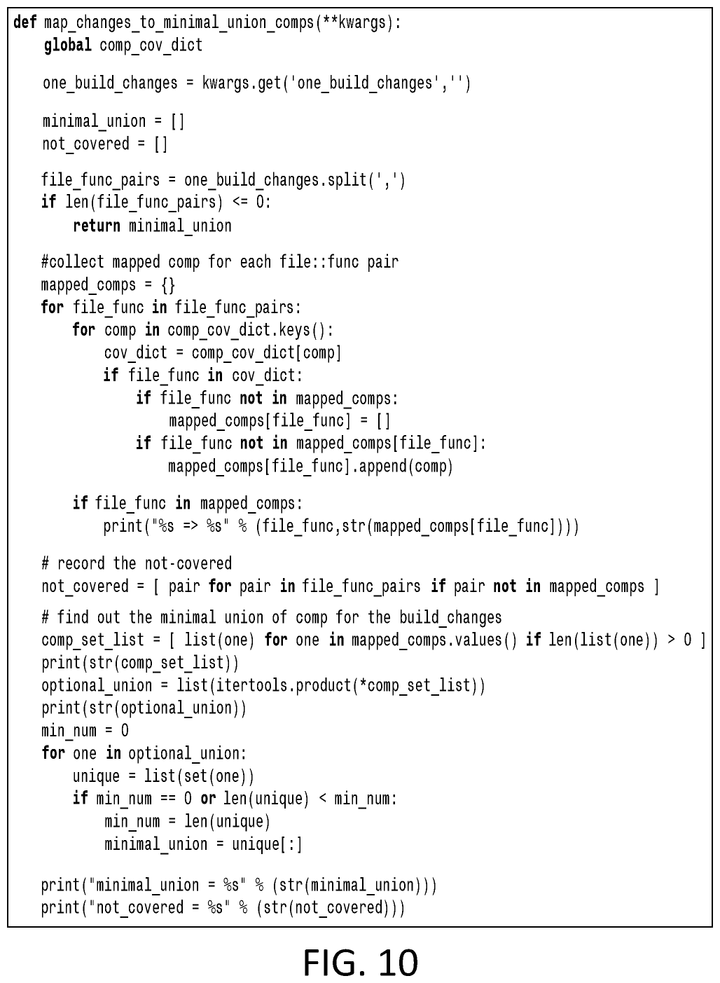

Because the group of Components X, Y and Z, has 3 components, while the group of Components X and W has only 2 components, the scope of testing needed to check all the changed source files can be minimized by narrowing the testing scope to a minimal number of components, namely, just Components X and W. That is, in this example, testing of all the changed source files can be accomplished by testing only 2 components. Testing the two Components X and W may be more efficient, in term of considerations such as, but not limited to, time and cost, than testing the three Components X, Y, and Z. Thus, the solution in this example is to test only Components X and W. Example pseudocode for implementing a minimal union approach such as that just described is disclosed in FIG. 10.

C.3 Process to Collect Test Cases Metric Data to Measure Value and Cost

In general, this process may operate to collect metric data for each test case, and then record the collected metric data into a DB. The metric data may be used later by a process for selecting test cases. Note that as used herein, a ‘test case’ embraces, but is not limited to, a new or modified test procedure for any new capability or code, where the test procedure may be performed to ensure that the code is free from errors and is operating correctly.

Following are some examples of metric data that may be collected for a test case:
Metric data used to measure the value of one or more test case— (1) testing points covered by each test case, and (2) failure proneness when specific source files or subroutines have changed; and
Metric data used to measure the cost of one or more test cases— (1) executing duration time, and (2) execution complexity such as, for example, the number of test rerun times needed to obtain a stable test result.

The testing points may be defined with different granularity or perspective, such as, for example, covered feature, covered CLI combinations, or covered source file or subroutine. As used herein, ‘testing points’ embrace source files and subroutines covered by a single test case. In fact, embodiments of the invention may be applicable to other type of testing points as well.

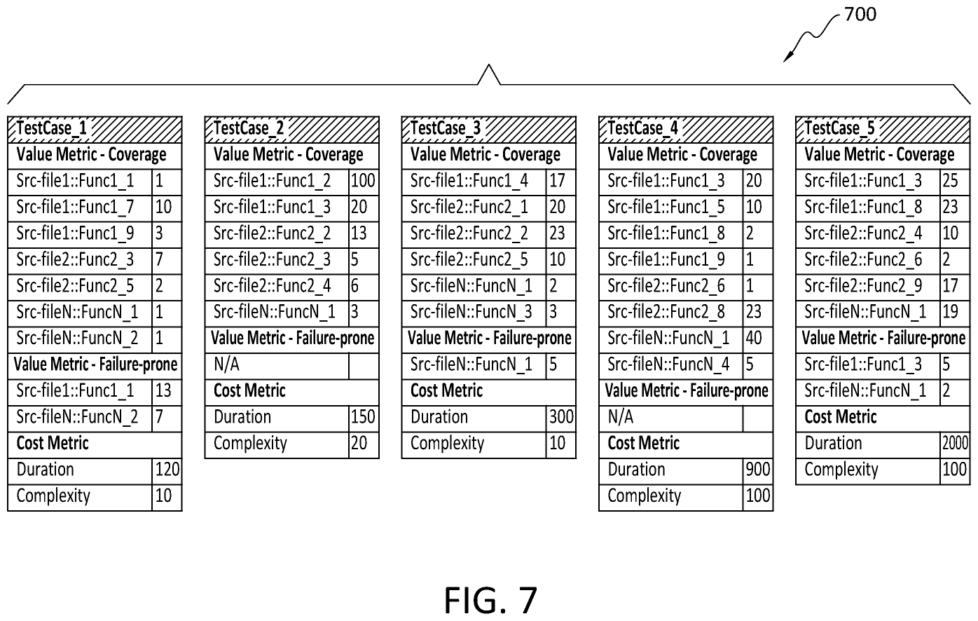

The collection of test case metrics may be run on-demand whenever new test cases are added in. The collection of test case metrics may also be performed together with regular testing processes so as to incrementally collect metric data. FIG. 7 discloses an example data structure 700 that may be used to store and organize metric data collected for each of a number of different test cases. With reference, for example, to TestCase_1 in the data structure 700, it can be seen that (1) the Src-file1::Func1_7 was called 10 times during the execution of that test case, (2) the test case fails 13 times when Src-file1::Func1_1 is changed, and (3) the test case normally takes 120 minutes to run and has a Complexity level of 10.

C.4 Process to Select Test Cases for Combined Coverage of Code Changes

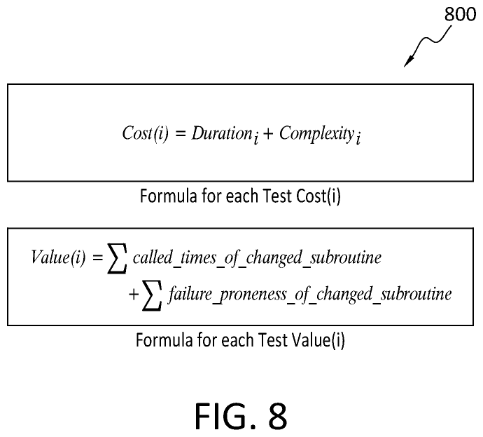

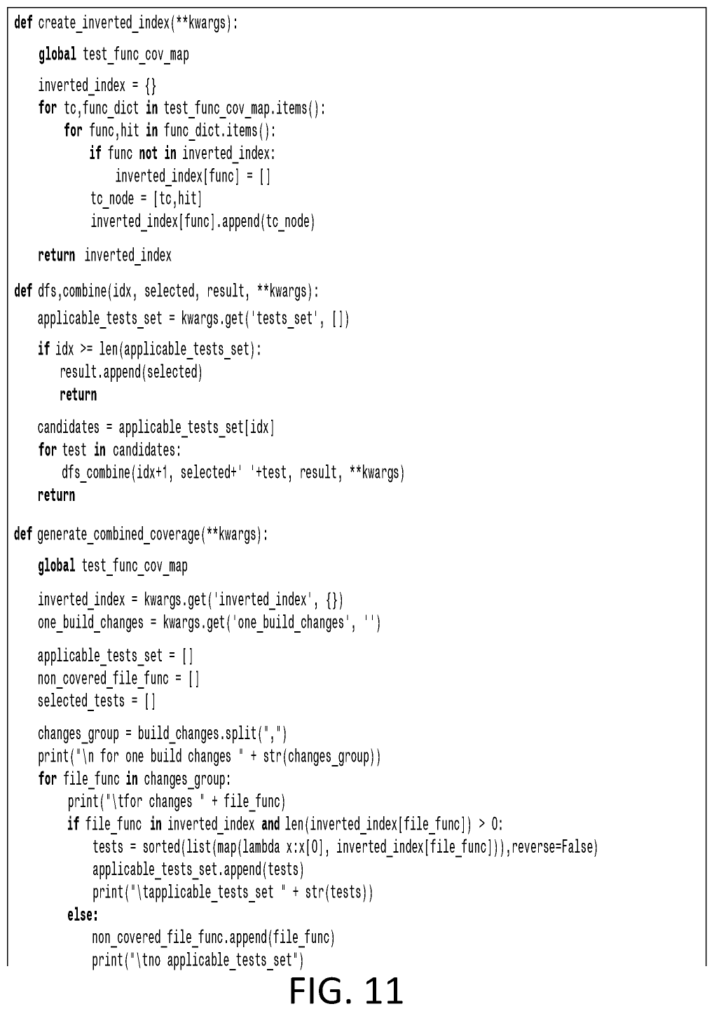

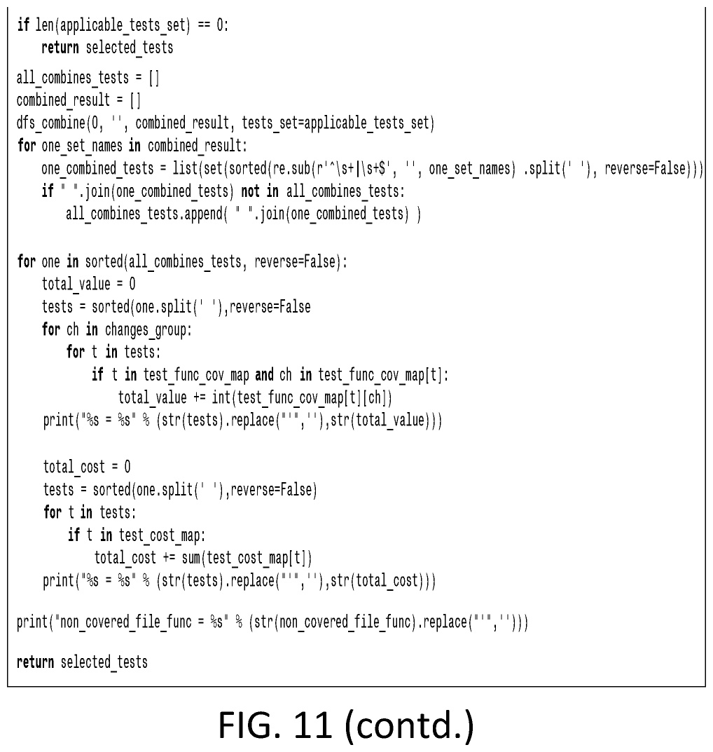

As described above, when code changes of a new build are mapped to specific components, all test cases from the mapped components may collectively serve as base pool for a test cases selecting process. Note that as it may be possible that test cases may be with overlapped coverage on source files or subroutines levels, and a single test case may not be enough for all code changes, example embodiments of the process may select multiple test cases for combined coverage for the changed source files and subroutines of each component. Example pseudocode for selecting test cases for a combined coverage with measurable cost( ) and value( ) is disclosed in FIG. 11. Aspects of an example process for test case selecting logic are as follows:
the process may use test cases of mapped components as candidate test cases pool;
the process may use a DFS (Depth First Searching) recursive algorithm to find out all possible combination of test cases for covering the changed source files and subroutines; and
the process may calculate both the Value( ) and Cost( ) of all test cases within each combination—when necessary, the identified combinations may be sorted then selected further based on their Value( ) and/or Cost( ).
   As used herein, the Cost( ) is defined as sum of all the Cost Metric items for each test case, and the Value( ) is defined as the total calling times of changed source file and subroutine. Formulas 800 for calculating Value( ) and Cost( ) are disclosed in FIG. 8.

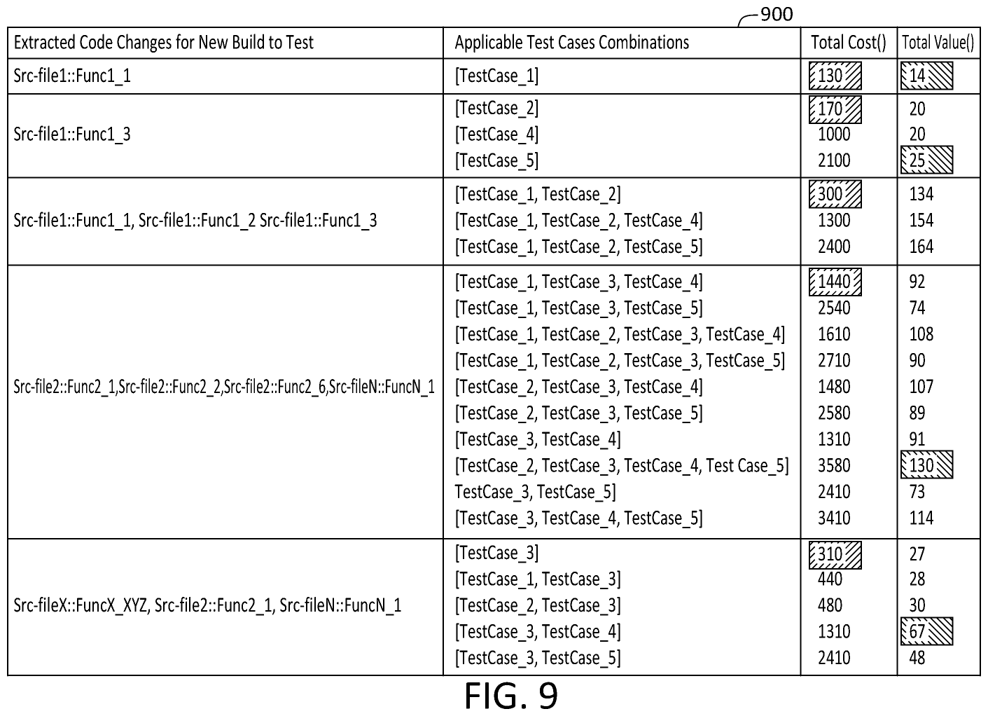

With reference now to the data structure 900 of FIG. 9, and based on the metric data mentioned above regarding example TestCase_1 through TestCase_5, for code changes of several new builds as below, the possible test case combinations and corresponding Cost( ) and Value( ) are shown.

In more detail regarding the example of FIG. 9:
for code changes of each new build in column 1, all applicable test cases combinations are listed in column 2 and each combination being in square brackets, the numerical value after square brackets is the total cost of the test cases of the combination;
the final selected combination is highlighted in column 3 (Total Cost) if considering the minimal Cost( ); and
the final selected combination is highlighted in column 4 (Total Value) if considering the maximal Value( ).
   The last row in the data structure 900 is an example in which some source file(s) or subroutine(s) are not covered by any test case.

In some embodiments, the most relevant test cases with minimal cost may be selected, and the selected test cases may provide combined coverage for the code changes of the new build.

### D. Example Methods

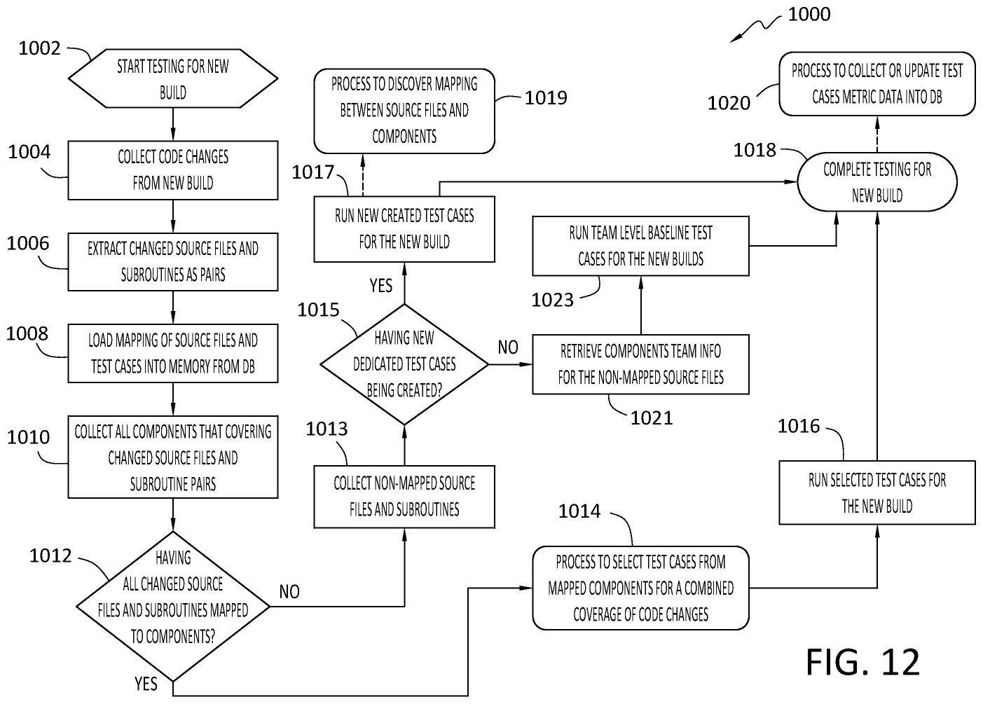

It is noted with respect to the disclosed methods, including the example method of FIG. 12, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 12, an example method 1000 according to some example embodiments is disclosed. The example method 1000 may include part, or all, of any of the other methods, processes, and operations, disclosed herein.

The example method 1000 may start 1002 with testing for a new software build. Code changes from the new build may be collected 1004, and source file—subroutine pairs extracted 1006 from the code changes. The mapping of source files and test cases may then be loaded into memory 1008 from a database, and all software components collected 1010 that cover one or more changed source—file subroutine pairs.

At this point, a check can be performed 1012 to determine if all changed source file—subroutine pairs have been mapped to one or more components. If this mapping has been performed, a process 1014 may be performed to select test cases from mapped components to define a combined coverage for the code changes. The selected tests may then be run 1016 for the new build. After completion 1018 of the testing, a process 1020 may be run to collect/update test cases metric data into the database.

If the check 1012 reveals that mapping has not been performed/completed, any non-mapped source files and subroutines may be collected 1013. Another check 1015 may then be performed to determine if any new, dedicated, test cases for the unmapped source files and subroutines have been created. If so, those new test cases may then be run 1017 for the new build, at which point the method 1000 may advance to 1018, discussed above. As well, after the new test cases have been run 1017, a process 1019 may be performed to discover a mapping between the, previously unmapped, source files and components.

If the check 1015 indicates that no new test cases have been created for the non-mapped source files and subroutines, the method 1000 may retrieve 1021 components team information for the non-mapped source files. Next, team level baseline test cases may be run 1023 for the new build, after which, the method 1000 may advance to 1018, discussed above.

### E. Further Example Embodiments

Following are some further example embodiments of the invention. These are presented only by way of example and are not intended to limit the scope of the invention in any way.

Embodiment 1. A method, comprising: discovering a mapping of software components to source files; mapping code changes of a software build to the software components; collecting metric data for test sets; and based on the mapping, and the collecting, selecting a test set that covers all the code changes so that when one or more tests of the test set are run, the tests operate to test all the code changes.

Embodiment 2. The method as recited in embodiment 1, wherein a text analysis methodology is used to discover the mapping of the software components to the source files.

Embodiment 3. The method as recited in any of embodiments 1-2, wherein the metric data is used as a basis for test set selection.

Embodiment 4. The method as recited in any of embodiments 1-3, wherein a measurable cost and/or value are calculated for the selected test set.

Embodiment 5. The method as recited in any of embodiments 1-24, wherein the mapping of components and source files is captured in an adjacency list.

Embodiment 6. The method as recited in any of embodiments 1-5, wherein the test set comprises a minimized union set of components.

Embodiment 7. The method as recited in embodiment 6, wherein the minimized union set of components is obtained by determining a minimum number of components, each of which requires a respective set of one or more source files to be tested, so that the minimized union set of components comprises a fewest number of components needed to ensure that all code changes for all components will be tested.

Embodiment 8. The method as recited in any of embodiments 1-7, further comprising defining a minimum and maximum number of components to which a source file is permitted to be mapped.

Embodiment 9. The method as recited in any of embodiments 1-8, wherein the metrics comprise any one or more of: code coverage; failure-proneness; and cost.

Embodiment 10. The method as recited in any of embodiments 1-9, wherein selecting the test set comprises finding all possible combinations of test sets for covering the changed source files and subroutines associated with the source files.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

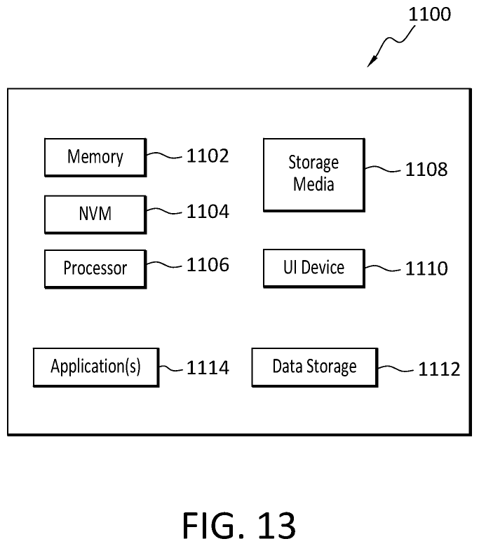

With reference briefly now to FIG. 13, any one or more of the entities disclosed, or implied, by FIGS. 1-12 and/or elsewhere herein, may take the form of, or include, or be implemented on, or hosted by, a physical computing device, one example of which is denoted at 1100. As well, where any of the aforementioned elements comprise or consist of a virtual machine (VM), that VM may constitute a virtualization of any combination of the physical components disclosed in FIG. 13.

In the example of FIG. 13, the physical computing device 1100 includes a memory 1102 which may include one, some, or all, of random access memory (RAM), non-volatile memory (NVM) 1104 such as NVRAM for example, read-only memory (ROM), and persistent memory, one or more hardware processors 1106, non-transitory storage media 1108, UI (user interface) device 1110, and data storage 1112. One or more of the memory components 1102 of the physical computing device 1100 may take the form of solid state device (SSD) storage. As well, one or more applications 1114 may be provided that comprise instructions executable by one or more hardware processors 1106 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
discovering a mapping of software components to source files;
mapping code changes of a software build to the software components;
collecting metric data for test cases; and
based on the mapping, and the collecting, selecting a test set that covers all the code changes so that when one or more tests of the test set are run, the tests operate to test all the code changes.

2. The method as recited in claim 1, wherein a text analysis methodology is used to discover the mapping of the software components to the source files.

3. The method as recited in claim 1, wherein the metric data is used as a basis for test set selection.

4. The method as recited in claim 1, wherein a measurable cost and/or value are calculated for the selected test set.

5. The method as recited in claim 1, wherein the mapping of components and source files is captured in an adjacency list.

6. The method as recited in claim 1, wherein the test set comprises a minimized union set of components.

7. The method as recited in claim 6, wherein the minimized union set of components is obtained by determining a minimum number of components, each of which requires a respective set of one or more source files to be tested, so that the minimized union set of components comprises a fewest number of components needed to ensure that all code changes for all components will be tested.

8. The method as recited in claim 1, further comprising defining a minimum and maximum number of components to which a source file is permitted to be mapped.

9. The method as recited in claim 1, wherein the metrics comprise any one or more of: code coverage; failure-proneness; and cost.

10. The method as recited in claim 1, wherein selecting the test set comprises finding all possible combinations of test sets for covering the changed source files and subroutines associated with the source files.

11. A non-transitory storage medium having stored therein instructions that are executable by one or more hardware processors to perform operations comprising:
discovering a mapping of software components to source files;
mapping code changes of a software build to the software components;
collecting metric data for test sets; and
based on the mapping, and the collecting, selecting a test set that covers all the code changes so that when one or more tests of the test set are run, the tests operate to test all the code changes.

12. The non-transitory storage medium as recited in claim 11, wherein a text analysis method is used to discover the mapping of the software components to the source files.

13. The non-transitory storage medium as recited in claim 11, wherein the metric data is used as a basis for test set selection.

14. The non-transitory storage medium as recited in claim 11, wherein a measurable cost and/or value are calculated for the selected test set.

15. The non-transitory storage medium as recited in claim 11, wherein the mapping of components and source files is captured in an adjacency list.

16. The non-transitory storage medium as recited in claim 11, wherein the test set comprises a minimized union set of components.

17. The non-transitory storage medium as recited in claim 16, wherein the minimized union set of components is obtained by determining a minimum number of components, each of which requires a respective set of one or more source files to be tested, so that the minimized union set of components comprises a fewest number of components needed to ensure that all code changes for all components will be tested.

18. The non-transitory storage medium as recited in claim 11, further comprising defining a minimum and maximum number of components to which a source file is permitted to be mapped.

19. The non-transitory storage medium as recited in claim 11, wherein the metrics comprise any one or more of: code coverage; failure-proneness; and cost.

20. The non-transitory storage medium as recited in claim 11, wherein selecting the test set comprises finding all possible combinations of test sets for covering the changed source files and subroutines associated with the source files.
